(19) United States
(12) Patent Application Publication
(10) Pub. No.: US 2019/0337406 A1
(43) Pub. Date: Nov. 7, 2019

(54) CHARGING STATION FOR VEHICLE OR ENERGY-STORAGE UNIT

(71) Applicant: VOLTABOX AG, Delbrueck (DE)

(72) Inventors: Christoph MINGENBACH, Bramsche (DE); Manfred SCHMIDT, Rinteln (DE); Juergen PAMPEL, Vlotho (DE)

(21) Appl. No.: 16/388,910

(22) Filed: Apr. 19, 2019

(30) Foreign Application Priority Data
May 2, 2018 (DE) 102018003560.4

(51) Int. Cl. B60L 53/30; H02J 3/38; H02S 10/40; H02J 7/00; H02J 7/35

(52) U.S. Cl. CPC B60L 53/30; H02J 3/383; H02J 7/355; H02S 10/40; H02J 7/0027; H02J 3/386

(57) ABSTRACT

A charging station comprising a charging unit and an electrical-energy storage unit is integrated into a trailer, the fixed body of a truck, the interchangeable system of a truck, the interchangeable container of a truck, a van, or a trailer towed by a truck or a car.

### FIELD OF THE INVENTION

The present invention relates to a charging apparatus or station. More particularly this invention concerns such an apparatus or station for charging an electric land vehicle, aircraft, water craft, or a stationary electric-energy storage unit.

### BACKGROUND OF THE INVENTION

Such a charging station typically has a charging unit that can charge an electrical energy storage system of an electrically powered land-based vehicle, aircraft, watercraft or a stationary electrical energy-storage unit.

Due to the increasing prevalence of electric drives in vehicles of all types, as well as due to the use of electrical energy for stationary energy use, providing a fast-charging infrastructure that meets higher demands is of the greatest significance.

### OBJECTS OF THE INVENTION

It is therefore an object of the present invention to provide an improved charging station for vehicle or energy-storage unit.

Another object is the provision of such an improved charging station for vehicle or energy-storage unit that overcomes the above-given disadvantages, in particular to provide a charging station for electrically powered land-based vehicles, aircraft, watercraft and stationary electrical energy-storage units, that can supply the electrical energy-storage units of land-based vehicles, aircraft, watercraft and stationary electrical energy-storage units with electrical energy on a large scale with comparatively low financial investments into the electrical infrastructure.

### SUMMARY OF THE INVENTION

According to the invention, this problem is solved by a charging station having an electrical energy storage unit and being integrated into a trailer, the fixed body of a truck, the interchangeable system of a truck, the interchangeable container of a truck, a van, or a trailer towed by a truck or a car.

Due to the mobile design of the inventive charging station, and if said charging station is equipped with a suitable electrical energy storage unit, the electrical energy stored in this electrical energy storage unit basically can be used to charge electrical energy-storage units in any location reachable by a trailer truck, a fixed-body truck, a van or a car, regardless whether those electrical energy-storage units are stationary or part of a mobile unit.

To expand the possible uses of the mobile charging station even further, it is advisable to include a generating system such as a diesel generator or a solar or wind power plant in the charging station, via which the electrical energy storage unit of the mobile charging station can be charged.

Of course, it also is possible to equip the mobile charging station with an electric mains connection, such that the electrical energy storage unit of the mobile charging station can be connected to any existing external electric grid, wherein the electrical energy storage unit of the mobile charging station is then chargeable via the electric mains connection by use of the existing external electric grid.

The electrical energy storage unit of the inventive mobile charging station can advantageously be designed from battery cells and a battery cell control system.

Furthermore, it is advisable to design the electrical energy storage unit of the inventive mobile charging station as having an AC/DC converter.

According to an advantageous development of the inventive charging station, the generating system and the electrical energy storage unit of the same can simultaneously be used for charging electrical energy-storage units.

It is possible to consolidate the generating system, the transformer unit and the electrical energy storage unit of the inventive mobile charging station into one energy supply unit of the same.

Alternatively, the transformer unit, the electrical energy storage unit, a power module, charging ports and a charging control system can be consolidated into a charging unit of the mobile charging station.

Advantageously, a power module of the mobile charging station includes a converter system, via which the electrical energy supplied by the transformer unit and the generating system can be converted to DC voltage and current levels suitable for charging the electrical energy storage unit and the electrical energy-storage unit.

The converter system of the power module should include power controllers for the AC/DC and DC/DC conversion, safety elements, switching elements, cooling elements, EMC filters and controllers, to which information can be conveyed via a higher-priority controller of the mobile charging station regarding which current and/or voltage level is required for a respective charging procedure.

Each charging port of the charging unit in the inventive mobile charging station should include a housing, a charging cable, a charging plug, cooling elements, a charging control system and a human machine interface (HMI); In addition it is advantageous if said charging port includes a calibrated DC energy meter.

The charging ports of the inventive mobile charging station can have a power output of 20 to 1,000 kW, preferably of up to 350 kW.

It is possible for the inventive charging station to have up to 15 charging ports, wherein 320 kW DC in a voltage range of 150 to 920 V, with the maximum power output provided at a voltage of at least 800 V, can be supplied via each charging port, and wherein the maximum volume of electrical energy per charging port is 240 kWh.

According to another advantageous development, the inventive mobile charging station includes a photovoltaic unit, via which the internal consumption of the mobile charging station can be covered and via which the mobile charging station can be interconnected.

### BRIEF DESCRIPTION OF THE DRAWING

The above and other objects, features, and advantages will become more readily apparent from the following description, reference being made to the accompanying drawing in which:

FIG. 1 is a schematic diagram of an embodiment of an inventive charging station;

FIG. 2 is a schematic diagram of a detail of the embodiment of FIG. 1;

FIG. 3 is a section through a trailer equipped with the embodiment of the inventive charging station shown in FIGS. 1 and 2;

FIG. 4 is perspective view of the trailer shown in FIG. 3;

FIG. 5 is a perspective view of parts of the embodiment of the inventive charging station shown in FIGS. 1 and 2, the parts being inside the trailer shown of FIGS. 3 and 4;

FIG. 6 is a perspective view of a module block of an energy storage unit of the embodiment of the inventive charging station shown in FIGS. 1 and 2;

FIG. 7 is a schematic diagram of two charging points of the embodiment of the inventive charging station shown in FIGS. 1 and 2; and

FIG. 8 is a schematic diagram of recharging units for charging the electrical energy-storage unit of the embodiment of the inventive charging station shown in FIGS. 1 and 2.

### SPECIFIC DESCRIPTION OF THE INVENTION

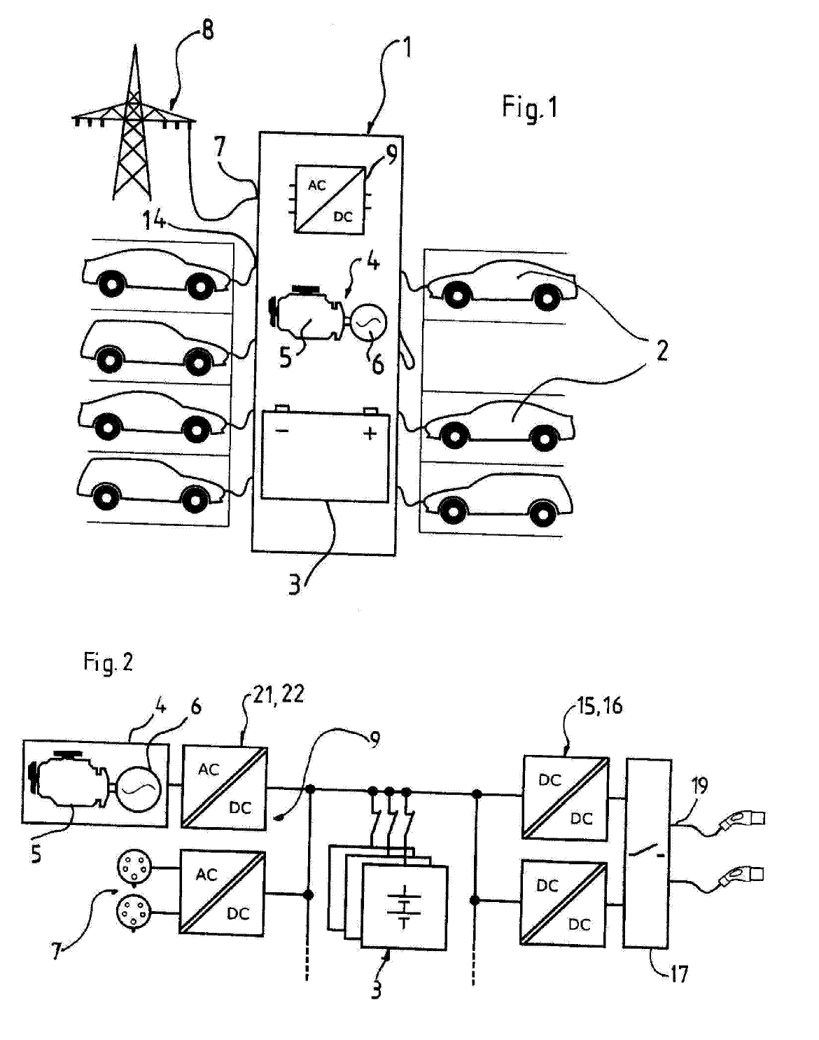

A charging station 1 for electrically powered land-based vehicles, aircraft, watercraft and stationary electrical energy-storage units, as explained in more detail in FIGS. 1 and 8 in the following, serves, when used as shown schematically in FIG. 1, to charge various land-based vehicles 2 or, respectively, their electrical energy-storage units (not shown in FIG. 1) with electrical energy.

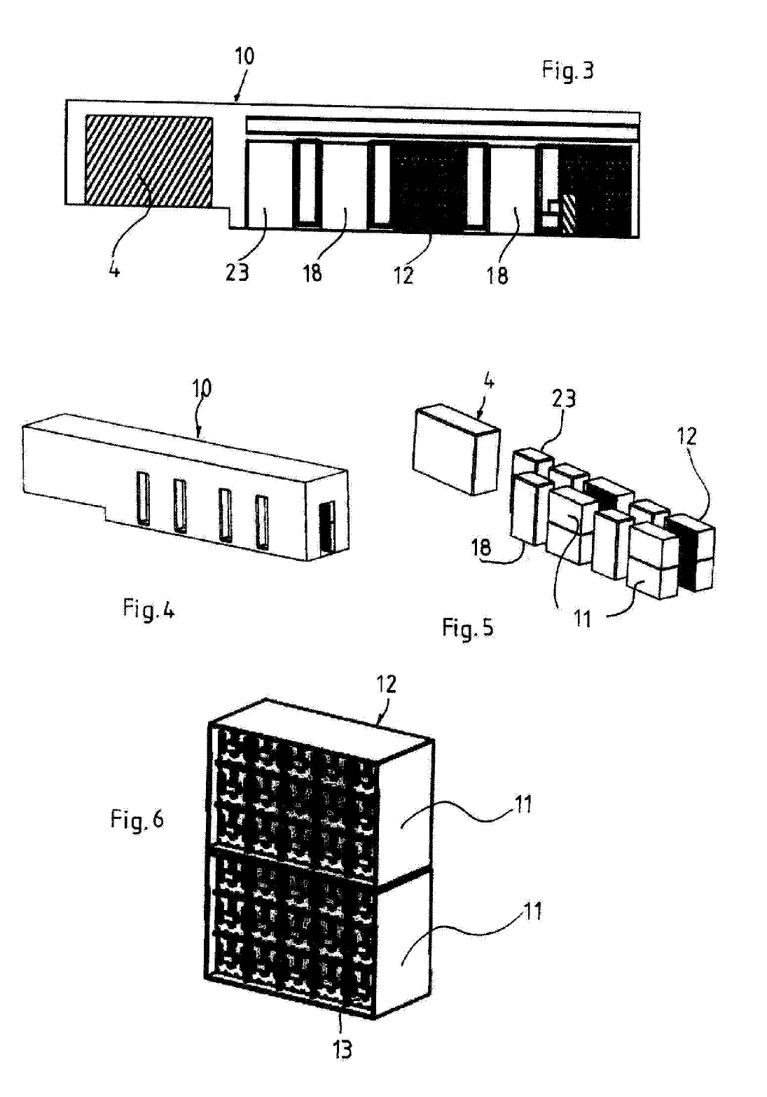

In the embodiment shown here, the charging station 1 is designed as a trailer 10 as will be explained further using FIGS. 3 to 5. Consequently, the charging station 1 shown in FIG. 1 can be used in any desired location to charge electrical energy-storage units that are not part of the charging station 1.

The charging station 1 includes an electrical energy storage unit designed as a modular storage battery 3 in the embodiment described in the following.

The storage battery 3 in the charging station 1 can be supplied or recharged with electrical energy via a generating system 4 that in the embodiment shown in FIG. 1 includes a diesel engine 5 and a generator 6.

In addition the mobile charging station 1 includes a mains connection 7, via which the storage battery 3 of the charging station 1 can be supplied or recharged with electrical energy from an electrical grid 8 represented in FIG. 1 by an electric conductor.

To be able to supply electrical energy to the electrical energy storage unit and/or the storage battery 3 of the charging station 1 via the mains connection 7 or the generating system 4, the charging station 1 is equipped with an AC/DC converter that converts the alternating current supplied to the charging station 1 via the mains connection 7 or generated in the generating system 4 can be converted into direct current that can be fed to the storage battery 3.

It should be noted that, instead of or in addition to the generating system 4 of the charging station 1 that includes the diesel engine 5 and the generator 6, a generating system based on a solar device or wind power can be provided.

The storage battery 3 of the charging station 1 shown in FIG. 1 that is designed in the form of a trailer 10 and therefore mobile, can store electrical energy in the amount of approximately 1.2 MWh. As evident particularly from FIGS. 3 and 6, the storage battery 3 is composed of a plurality of identical storage battery modules 11, and, as particularly evident from FIG. 6, two storage battery modules 11 are on top of each other, making up a storage battery module block 12. As can be seen in an overview of FIGS. 4 and 5, the charging station 1 includes four storage battery module blocks 12 containing two storage battery modules 11 each. Each storage battery module 11 is composed of a plurality of batteries 13 that each include battery cell controllers not shown here.

In the embodiment shown here, the mobile charging station 1 has eight charging connectors 14 that can be used to feed electrical energy from the mobile charging station 1 to charge external electrical energy-storage units, such as electrical energy-storage units of the land-based vehicles 2 in the case of the application shown in FIG. 1. Each of the charging connectors 14 can be operated with a charging output or capacity of 180 kW.

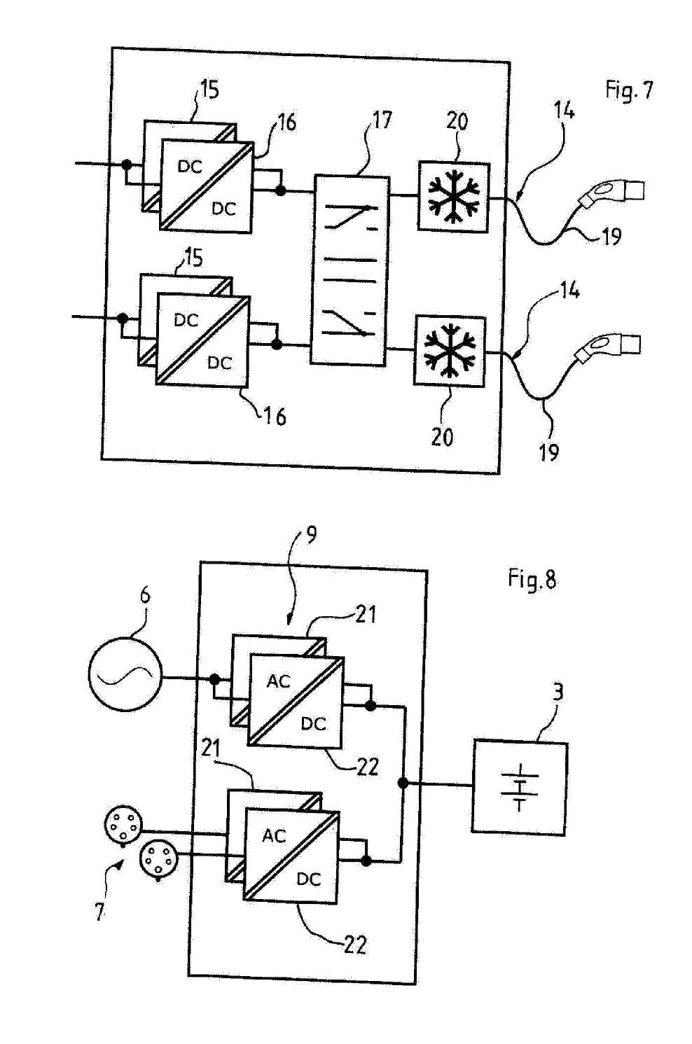

As particularly shown in FIG. 7, which shows two charging connectors 14, each charging connector 14 includes two power blocks 15 and 16 each having a power output of 90 kW. Each pair of charging connectors 14 is associated with a switched link 17 via which the two power output blocks 15 and 16, which are associated with the two charging connectors 14, can be linked. The power output thus linked can then be provided to either of the two charging connectors 14 as desired. This charging connector 14 is then capable of a power output of 350 kW.

As is evident from an overview of the FIGS. 1, 3, 5 and 7, each respective control cabinet 18 has two charging connectors 14 in the embodiment of the charging station 1 shown here. Each charging cable 19 of the charging connectors 14 is provided with a cooler 20. Thus, as previously mentioned, a power output of 350 kW can be made available at both charging connectors 14 when the switched link 17 is in the appropriate position.

In the embodiment of the mobile charging station 1 shown here, the charging points or charging connectors 14 associated with each respective control cabinet 18 can be coupled together, such that the mobile charging station 1 shown as one embodiment in the drawings has four charging points or charging connectors 14 with power output or capacity of 350 kW each.

The power transistors are made of silicon carbide (SiC). The switching frequencies lie above 16 kHz and are therefore inaudible. Their efficiency of approximately 97% is comparatively high. Due to the low heat generation, the cooling system can be designed to be extremely low-noise.

The DC input voltage of the charging block including the two charging points or charging connectors 14 shown in FIG. 7 is 450 to 750 V. Two output voltage ranges can be provided by this charging block, namely 150 to 480 V and 300 to 960 V, and switching between the two ranges is performed automatically. The control cabinet 18 provided for this purpose is associated with the charging block shown in FIG. 7 and would then have a weight of approximately 550 kg and dimensions of approximately 1,200×800×2,000 mm.

As can be best seen from an overview of FIGS. 1 and 8, the generator 6 of the generating system 4 and the mains connection 7 of the mobile charging station 1 are connected with the storage battery 3 via the AC/DC power blocks 21 and 22. The components used to make up the AC/DC power blocks 21 and 22 are identical as far as possible to the corresponding components used in the power blocks 15 and 16 associated with the charging connectors 14. Consequently, maintenance of replacement parts for the charging station 1 is simplified.

As the components used for the recharging of the storage battery 3 of the charging station 1 also are SiC components, the design can be kept light and compact, the components are highly efficient and the operation is low-noise. If one of the AC/DC power blocks fails, 270 kW of recharging power remain available for the storage battery 3 of the charging station 1, as each of the AC/DC power blocks 21 and 22, which are used in the recharging process, can have a charging power output of 90 kW.

The components shown in FIG. 8, which are used for recharging the storage battery 3, are consolidated in the control cabinet 23 shown in FIGS. 3 and 5 that is associated with the generating system 4.

The mains voltage is 400/480 V±10% at 50/60 Hz. The use of active mains rectification (cos f>99%) results in a high power factor.

The charging station 1 in the embodiment explained in the drawings is contained inside the trailer 10 shown in FIGS. 3 and 4. Here, the generating system 4 is located in the front of the trailer 10, in the area above the coupling that has a lower vertical height compared to the rest of the trailer 10. The control cabinet 23 associated with the generating system 4 and the mains connection 7 is between the generating system 4 and the four control cabinets 18 associated with the charging points or charging connectors 14 and the battery module blocks 12.

The storage battery 3 is designed as a contiguous storage battery composed of strings that can be disengaged individually, as best shown in FIG. 2. External energy-storage units can be charged from any charging connector 14 of the charging station 1 at any time. There is no loss due to energy redistribution between the charging points or charging connectors 14. The battery storage capacity installed in the charging station 1 can be scaled, since all the charging points or charging connectors 14 have access to the common storage battery.

The mains connection 7 and the generating system 4 can be operated in parallel, and any electrical energy thus provided obviously can be used both for charging the storage battery 3 and/or for charging external electrical energy-storage units connected to the charging station 1 via charging points or the charging connectors 14.

We claim:

1. A charging station for electrically powered land-based vehicles, aircraft, watercraft and stationary electrical energy-storage units, the charging station comprising:
a charging unit that can charge an electrical energy-storage unit of the electrically powered land-based vehicle, aircraft, watercraft or stationary electrical energy-storage unit can be charged;
an electrical energy storage unit; and
a trailer, a fixed body of a truck, an interchangeable system of a truck, an interchangeable container of a truck, a van, a trailer towed by a truck, or a car holding charging unit and the electrical-energy storage unit of the charging station.

2. The charging station according to claim 1, further comprising:
a generating system or a solar or wind power plant that charges the electrical energy storage unit of the mobile charging station.

3. The charging station according to claim 1, further comprising:
an electrical mains connection connectable to an external electrical grid and via which the electrical energy storage unit of the mobile charging station can be charged.

4. The charging station according to claim 1, wherein the electrical energy storage unit of the mobile charging station includes battery cells and a battery cell controller.

5. The charging station according to claim 1, wherein the electrical-energy storage unit of the mobile charging station includes an AC/DC converter.

6. The charging station according claim 2, wherein the generating system and the electrical energy storage unit of the mobile charging station are a hybrid system and can be used simultaneously for charging electrical energy-storage units.

7. The charging station according to claim 2, wherein the generating system and the electrical energy storage unit are consolidated into an energy supply unit of the mobile charging station.

8. The charging station according to any of claim 1, wherein a transformer unit, the electrical energy storage unit, a power module, charging ports and a charging control system are consolidated into a charging unit of the mobile charging station.

9. The charging station according to claim 8, wherein the power module includes a converter device that can convert electrical energy provided by the transformer unit and the generating system to a DC voltage and current level suitable for charging the electrical energy storage unit of the mobile charging station and the electrical energy-storage units.

10. The charging station according to claim 9, wherein the converter device of the power module includes power controllers for the AC/DC and DC/DC conversion, safety elements, switching elements, cooling elements, EMC filters and controllers to which information can be conveyed via a higher-priority controller of the mobile charging station regarding which current and/or voltage level is required for a respective charging procedure.

11. The charging station according to claim 8, wherein each charging port of the charging unit includes a housing, a charging cable, a charging plug, cooling elements, a charging control system and a human machine interface; In addition it is advantageous if said charging port includes a calibrated DC energy meter.

12. The charging station according to claim 8, further comprising:
charging ports with a power output of 20 to 1,000 kW.

13. The charging station according to claim 8, further comprising:
up to 15 charging ports for supplying 320 kW DC in a voltage range of 150 to 920 V, with the maximum power output provided at a voltage of at least 800 V via each charging port, the maximum volume of electrical energy per charging port being 240 kWh.

14. The charging station according to claim 1, further comprising:
a photovoltaic unit for supplying the internal consumption of the mobile charging station and via which the mobile charging station can be interconnected.
